(19) United States
(12) Patent Application Publication
(10) Pub. No.: US 2004/0081503 A1
(43) Pub. Date: Apr. 29, 2004

(54) Polyester (PolyethyleneTerephthlate) light reflecting characters on computer key caps

(76) Inventors: Hakeem Al-Raheem, Turlock, CA (US); Michelle Huang, San Gabriel, CA (US)

Correspondence Address: Hakeem Al-Raheem, 2246 Typhoon Court, Turlock, CA, 95380, US

(21) Appl. No.: 10/283,864

(22) Filed: Oct. 29, 2002

(51) Int. Cl. B41J 5/08

(52) U.S. Cl. 400/487

(57) ABSTRACT

The present invention relates to the uses of polyester (Polyethylene Terephthlate) light reflecting characters on computer key caps, providing reflections from natural external light sources, providing human beings a luminous reflection thus enhancing human beings abilities to see and read computer key cap characters on a standard QWERTY computer keyboard in low lighting.

Polyester (Polyethylene Terephthlate) light reflecting characters in the form(s) and shape(s) of every standard letter(s), symbol(s), word(s), and number(s) to be securely fixed and adhered in configuration on the superior surface(s) of a standard QWERTY computers keyboard key cap(s).

### 2. DESCRIPTION OF THE FIGURE(S) OF THE DRAWING

Any broken line illustration of environmental structure in the drawing is not part of the design sought to be patented.

FIG. 1 is a front elevation superior view of a three-dimensional graphical art representing a conventional standard computer keyboard with key caps.

FIG. 2 is an enlarged front elevation superior view of a three-dimensional graphical art image representing of the said conventional standard computer key caps including images 1, 2 and 3.

FIG. 2 images 2 and 3 are mirror images of FIG. 1 representing a conventional standard computer keyboard with key caps.

FIG. 2—image 1 is an enlarged front elevation superior view of a said polyester (Polyethylene Terephthlate) light reflecting characters represented in the shape of the letter “E”.

FIG. 2—image 2 is an enlarged front elevation superior view of a three-dimensional graphical art representing of the said conventional computer keyboard key cap superior surface.

FIG. 2—image 3 is an enlarged front elevation superior view of a three-dimensional graphical art representing of the said conventional computer keyboard key cap lower base.

FIG. 3 is an enlarged front elevation superior view of a three-dimensional graphical art mirror image representing of the said conventional standard computer key cap including in images 1, 2 and 3.

FIG. 3—image 1 is an enlarged front elevation superior view of a said polyester (Polyethylene Terephthlate) light reflecting characters represented in the shape of the letter “E” securely fixed or adhered in configuration on the conventional computer keyboard key cap superior surface.

FIG. 3—image 2 is an enlarged front elevation superior view of a three-dimensional graphical art representing of the said conventional computer keyboard key cap superior surface.

FIG. 3—image 3 is an enlarged front elevation superior view of a three-dimensional graphical art representing of the said conventional computer keyboard key cap lower base.

FIG. 4 is an enlarged lateral view of a three-dimensional graphical art mirror image representing of the said conventional standard computer key cap including in images 1, 2 and 3.

FIG. 4—image 1 is an enlarged lateral view of a said polyester (Polyethylene Terephthlate) light reflecting characters represented in the shape of the letter “E” securely fixed or adhered in configuration on the conventional computer keyboard key cap superior surface.

FIG. 4—image 2 is an enlarged lateral view of a three-dimensional graphical art representing of the said conventional computer keyboard key cap superior surface.

FIG. 4—image 3 is an enlarged lateral view of a three-dimensional graphical art representing of the said conventional computer keyboard key cap lower base.

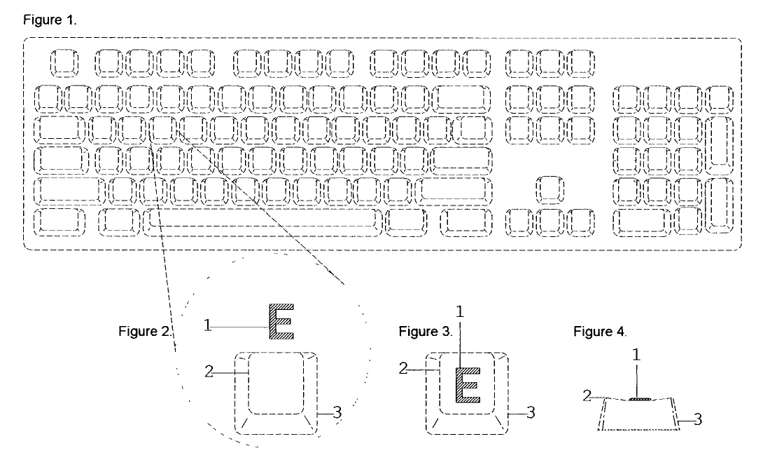

### 3. FEATURE DESCRIPTION

### Background of the Invention

The present invention relates to the uses of polyester (Polyethylene Terephthlate) light reflecting characters on computer key caps. Polyester (Polyethylene Terephthlate) light reflecting characters are capable of reflecting photons of natural light providing Human beings enhanced visual light reflective illumination on computer key caps from natural light. The said key cap polyester (Polyethylene Terephthlate) light reflecting characters shaped in standard letter(s), symbol(s), word(s), and number(s) would enhance human beings sight while reading computer key cap character(s) in low lighting.

This includes the using of polyester (Polyethylene Terephthlate) light reflecting characters in the form(s) and shape(s) of every standard lefter(s), symbol(s), word(s), and number(s) to be securely fixed and adhered in configuration on standard QWERTY computer(s) keyboard key cap(s), will greatly enhance human beings abilities to operate computers while in areas of low lighting.

### SUMMARY OF THE INVENTION

More specifically, the present invention relates to computer keyboards having polyester (Polyethylene Terephthlate) light reflecting characters on computer key caps.

The polyester (Polyethylene Terephthlate) light reflecting characters on computer key caps are able to reflect and refract external light providing a luminous reflection thus enhancing human beings abilities to read computer key cap characters on a standard QWERTY computer keyboard. The polyester (Polyethylene Terephthlate) light reflecting characters is fixed or adhered in configuration to the superior surface(s) represents in the form(s) of standard letter(s), symbol(s), word(s), and number(s) used on standard QWERTY computer keyboard key cap(s).

The body of each polyester (Polyethylene Terephthlate) light reflecting characters on key caps is shaped in the form(s) to key cap(s) standard contour on the computer key cap(s) superior surface(s). The character(s) are fixed and adhered in configuration to the superior surface of the key cap.

### DESCRIPTION OF THE PREFERRED EMBODIMENT

The disclosure contains several different embodiments according to this invention. Where appropriate, like components or features will be referenced with the same numeral. To avoid redundant discussion, only different or distinct features of one embodiment as compared to another embodiment will be discussed in detail.

Polyester (Polyethylene Terephthlate) light reflecting character is shown in FIG. 2—image1, FIG. 3—image 1 and FIG. 4—image 1.

The said polyester (Polyethylene Terephthlate) light reflecting characters is represented in the shape of the letter “E” securely fixed or adhered in configuration on the conventional computer keyboard key cap superior surface, shown in FIG. 3—image 1 and FIG. 4—image 1.

I(We) claim the following:

1. The polyester (Polyethylene Terephthlate) light reflecting characters, are natural light reflective character(s) and shape(s) of every standard conventional QWERTY computer key cap's letter(s), symbol(s), word(s), and number(s) and securely fixed or adhered, in configuration on the superior surface of a plurality conventional standard QWERTY computer keyboard's key cap(s) superior surface(s) therein.
